(19) United States
(12) Patent Application Publication
(10) Pub. No.: US 2016/0278434 A1
(43) Pub. Date: Sep. 29, 2016

(54) ELECTRONIC CIGARETTE, ATOMIZER AND CONNECTING TERMINAL OF HEATING WIRE THEREOF

(71) Applicant: Qiuming Liu, Shenzhen (CN)

(72) Inventor: Qiuming LIU, Guangdong (CN)

(21) Appl. No.: 14/361,402

(22) PCT Filed: Dec. 4, 2013
(86) PCT No.: PCT/CN2013/088500

§ 371 Date: May 29, 2014

(30) Foreign Application Priority Data
Nov. 19, 2013 (CN) 201320733181.X

(51) Int. Cl. A24F 47/00; H05B 1/02

(52) U.S. Cl. CPC A24F 47/008; H05B 1/0297

(57) ABSTRACT

A connecting terminal of a heating wire according to the present application is made of white copper. The pure copper added with nickel may significantly increase the strength, corrosion resistance, hardness and pyroelectricity and reduce the temperature coefficient of resistivity. The white copper has a good ductility, a high hardness and an aesthetic color, and has a remarkable corrosion resistance, and has a large amount of nickel element, since nickel has a better corrosion resistance, an oxidation film may be formed on a surface of the connecting terminal, which may further prevent an oxidizing reaction from occurring between the connecting terminal and air. Thus, the connecting terminal made of white copper also has great corrosion resistance and better stability, which may effectively avoid the rusting of the connecting terminal in a humid environment, and further avoid a break in a circuit of the heating wire.

The present application claims the benefit of priority to Chinese patent application No. 201320733181.X titled “ELECTRONIC CIGARETTE, ATOMIZER AND CONNECTING TERMINAL OF HEATING WIRE THEREOF”, filed with the Chinese State Intellectual Property Office on Nov. 19, 2013, the entire disclosure of which is incorporated herein by reference.

### TECHNICAL FIELD

The present application relates to the field of electronic cigarette manufacture technology, and particularly to an electronic cigarette, an atomizer and a connecting terminal of a heating wire thereof.

### BACKGROUND

An electronic cigarette, also known as a virtual cigarette, can atomize, by heating, liquid of tobacco flavor to smoke-like state to be smoked by a smoker, and is mainly used for smoking cessation or cigarette substitution. The electronic cigarette has the same appearance and similar flavor as the cigarette. Since the electronic cigarette does not contain harmful ingredients in the cigarette, such as tar, suspended particles, and etc., and does not generate diffused or smoky second-hand smoke, thus the electronic cigarette is very popular.

The electronic cigarette includes a containing chamber for containing liquid and a heating chamber for gasifying the liquid, and the electronic cigarette further includes a liquid guide cord which is in contact with the liquid and configured to transfer the liquid to the heating chamber, and a heating wire in contact with the liquid guide cord. Each of two ends of the heating wire is provided with a connecting terminal, and the two connecting terminals are connected to electronic wires respectively, and are connected to an anode and a cathode of a battery via the electronic wires respectively, thus power is supplied to the heating wire. A temperature of the heating wire being electrified is increased, which further causes a temperature of the liquid guide cord to increase so as to atomize the liquid.

In the conventional technology, the connecting terminals of the heating wire are all made of brass, however, the connecting terminal made of brass is apt to rust in a humid environment, and may even cause a break in a circuit of the heating wire in severe cases. Furthermore, verdigris generated by the connecting terminal may be dissolved in the liquid, which adversely affects the flavor of the liquid, and may also harm the human body.

In view of this, a technical problem to be solved presently by those skilled in the art is to effectively solve the problem that a break in the circuit of the heating wire may be caused because the connecting terminal of the heating wire is apt to rust.

### SUMMARY

In view of this, a first object of the present application is to provide a connecting terminal of a heating wire, which may effectively solve the problem that a break in a circuit of the heating wire may be caused because the connecting terminal of the heating wire is apt to rust, a second object of the present application is to provide an atomizer including the connecting terminal of the heating wire, and a third object of the present application is to provide an electronic cigarette including the atomizer.

In order to achieve the first object, the following technical solutions are provided according to the present application.

A connecting terminal of a heating wire is configured to connect a heating wire to an electronic wire of an electronic cigarette, and the electronic wire is configured to supply power to the heating wire, wherein the connecting terminal is made of white copper.

Preferably, in the connecting terminal of the heating wire, the white copper contains 17.0% to 35.0% nickel, by weight.

Preferably, in the connecting terminal of the heating wire, the white copper is a copper-nickel binary alloy.

Preferably, in the connecting terminal of the heating wire, the white copper is a multicomponent alloy formed by adding one or more components of iron, zinc, aluminum, and manganese into copper and nickel.

Preferably, in the connecting terminal of the heating wire, the connecting terminal is a riveting terminal riveted to the heating wire and the electronic wire.

An atomizer, configured to form an electronic cigarette in combination with a battery rod, includes a liquid guide cord, a heating wire in contact with the liquid guide cord, a connecting terminal electrically connected to the heating wire, and an electronic wire electrically connected to the connecting terminal and configured to supply power to the heating wire, wherein the connecting terminal of the heating wire is the connecting terminal of the heating wire according to any one of the above technical solutions.

Preferably, in the atomizer, the liquid guide cord is a fiber cord.

Preferably, in the atomizer, the heating wire is wound on the liquid guide cord.

An electronic cigarette includes an atomizer and a battery rod, and the atomizer is the atomizer according to any one of the above technical solutions.

Preferably, in the electronic cigarette, an outer surface of the electronic cigarette is provided with a protruding friction portion.

The connecting terminal of the heating wire according to the present application is a connecting terminal made of white copper, that is, the connecting terminal of the heating wire is entirely made of white copper. The white copper is a copper-based alloy with nickel as a main addition, and has a silvery color and metallic luster. The pure copper added with nickel may significantly increase the strength, corrosion resistance, hardness and pyroelectricity and reduce the temperature coefficient of resistivity. Compared with other copper alloys, the white cooper has better mechanical properties and physical properties, and has a good ductility, a high hardness and an aesthetic color, and has a remarkable corrosion resistance. Furthermore, the white copper has a large amount of nickel element, since nickel has a better corrosion resistance, an oxidation film may be formed on a surface of the connecting terminal, which may further prevent an oxidizing reaction from occurring between the connecting terminal and air. Thus, the connecting terminal made of white copper also has advantages of great corrosion resistance and better stability, which may effectively avoid the rusting of the connecting terminal in a humid environment, and further avoid a break in a circuit of the heating wire, therefore, no verdigris will be dissolved in the liquid, thus will not adversely affect the flavor of the liquid and will not harm the human body.

In order to achieve the second object, an atomizer according to the present application includes the connecting terminal of the heating wire according to any one of the above technical solutions. Since the connecting terminal of the heating wire has the above technical effects, the atomizer having the same also has the corresponding technical effects.

In order to achieve the third object, an electronic cigarette according to the present application includes the atomizer according to any one of the above technical solutions. Since the atomizer has the above technical effects, the electronic cigarette having the atomizer also has the corresponding technical effects.

### BRIEF DESCRIPTION OF THE DRAWINGS

FIG. 1 is a schematic view showing the assembly of a heating wire, a liquid guide cord, a connecting terminal and an electronic wire according to an embodiment of the present application;

FIG. 2 is a schematic sectional view showing the structure of an atomizer according to an embodiment of the present application; and

FIG. 3 is a schematic view showing the structure of an electronic cigarette according to an embodiment of the present application.

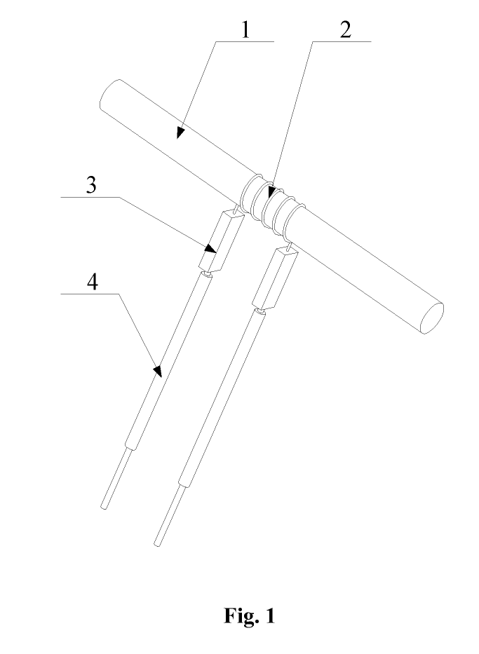

### REFERENCE NUMERALS IN FIGS. 1 to 3

1 liquid guide cord, 2 heating wire, 3 connecting terminal, 4 electronic wire, 5 friction portion, 6 connecting member, 61 outer electrode, 62 inner electrode, 7 liquid storage cotton, 8 air pipe, 9 atomizing seat, A electronic cigarette, and B atomizer.

### DETAILED DESCRIPTION

A first object of the present application is to provide a connecting terminal of a heating wire, which may effectively solve the problem that a break in a circuit of the heating wire may be caused because the connecting terminal of the heating wire is apt to rust, a second object of the present application is to provide an atomizer including the connecting terminal of the heating wire, and a third object of the present application is to provide an electronic cigarette including the atomizer.

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the protection scope of the present application.

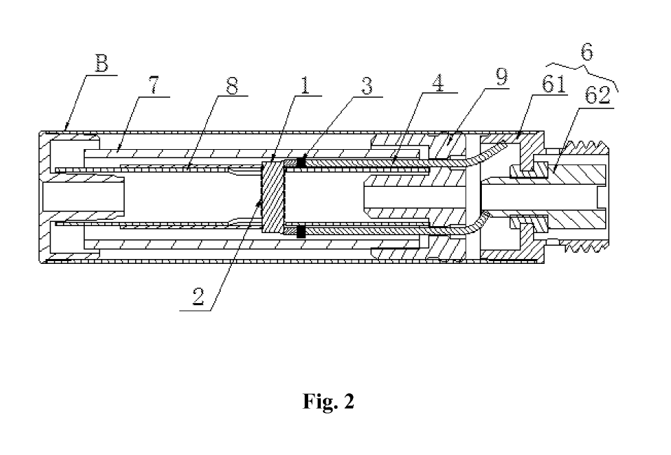

Referring to FIGS. 1 to 2, a connecting terminal 3 of a heating wire 2 according to an embodiment of the present application is configured to connect the heating wire 2 to an electronic wire 4 of the electronic cigarette. The electronic wire 4 is configured to supply power to the heating wire 2, and the connecting terminal 3 may be made of white copper, that is, the connecting terminal 3 of the heating wire 2 is entirely made of white copper. The white copper is a copper-based alloy with nickel as a main addition, and has a silvery color and metallic luster. The pure copper added with nickel may significantly increase the strength, corrosion resistance, hardness and pyroelectricity and reduce the temperature coefficient of resistivity. Compared with other copper alloys, the white cooper has better mechanical properties and physical properties, and has a good ductility, a high hardness and an aesthetic color, and has a remarkable corrosion resistance. Furthermore, the white copper has a large amount of nickel element, since nickel has a better corrosion resistance, an oxidation film may be formed on a surface of the connecting terminal 3, which may further prevent an oxidizing reaction from occurring between the connecting terminal 3 and air. Thus, the connecting terminal 3 made of white copper also has advantages of great corrosion resistance and better stability, which may effectively avoid the rusting of the connecting terminal 3 in a humid environment, and further avoid a break in a circuit of the heating wire 2, therefore, no verdigris will be dissolved in the liquid, thus will not adversely affect the flavor of the liquid and will not harm the human body.

The white copper may be a copper-nickel binary alloy, and may also be a multicomponent alloy formed by adding one or more components of iron, zinc, aluminum, and manganese into copper and nickel. The white copper may contain 17.0% to 35.0% nickel, by weight. Preferably, the white copper contains 30% nickel, by weight, and in this case, the white copper has the best corrosion resistance. In this embodiment, the connecting terminal 3 is made of nickel silver alloy, that is, the white copper contains 17.0% to 19.0% nickel, by weight.

Furthermore, the connecting terminal 3 may be a riveting terminal riveted to the heating wire 2 and the electronic wire 4, that is, inside the riveting terminal, the riveting terminal and each of the heating wire 2 and the electronic wire 4 squeeze one another to be in contact with one another, so as to achieve the electric connection between the heating wire 2 and the electronic wire 4. A riveting hole may be provided in the connecting terminal 3, and the electronic wire 4 and the connecting terminal 3 are both riveted to the riveting terminal and are in close contact with each other, so as to achieve the electric connection. Apparently, the connecting terminal 3 may also be connected to the electronic wire 4 by welding, and the connection manner is not limited herein.

Referring to FIG. 1 and FIG. 2, based on the connecting terminal 3 of the heating wire 2 according to the above embodiments, an atomizer B is further provided according to the present application and is configured to form an electronic cigarette in combination with a battery rod. The atomizer B includes a liquid guide cord 1, a heating wire 2 in contact with the liquid guide cord 1, a connecting terminal 3 electrically connected to the heating wire 2, and an electronic wire 4 electrically connected to the connecting terminal 3 and configured to supply power to the heating wire 2. The connecting terminal 3 of the heating wire 2 may be the connecting terminal 3 according to any one of the above embodiments, that is, the connecting terminal 3 made of white copper. The connecting terminal 3 of the atomizer has the advantages and effects of the connecting terminal 3 in any one of the above embodiments.

In this embodiment, the atomizer B further includes a connecting member 6 configured to connect the battery rod, a liquid storage cotton 7 for supplying liquid to the liquid guide cord 1, an air pipe 8 for fixing the heating wire 2, and an atomizing seat 9 for fixing the air pipe 8. The connecting member 6 includes an outer electrode 61 and an inner electrode 62 electrically connected to the electronic wires 4, respectively. When the atomizer B is connected to the battery rod, the outer electrode 61 and the inner electrode 62 are both electrically connected to the battery rod. It may be appreciated that, the liquid storage cotton 7 for supplying liquid to the liquid guide cord 1 may be substituted by a liquid cup. When the atomizer is in operation, the battery rod provides current to the heating wire 2 to atomize the liquid on the liquid guide cord 1. The smoke formed by atomizing the liquid may be directed into a mouth of the smoker via the air pipe 8.

Preferably, the liquid guide cord 1 of the atomizer B may be a fiber cord, the main ingredient of which is silicon dioxide, that is, a glass fiber cord. Apparently, the liquid guide cord 1 may also be a cord made of other materials, such as a nylon fiber cord, and the material of the liquid guide cord 1 is not limited herein.

In addition, for further increasing the contact area between the liquid guide cord 1 and the heating wire 2 to increase the temperature of the liquid guide cord 1 more quickly, the liquid guide cord 1 may be wound on the liquid guide cord 1. Apparently, the heating wire 2 and the liquid guide cord 1 may be arranged side by side to be in contact with one another, and the connection manner is not limited herein.

It is to be noted that, the connecting terminal 3 may be a riveting terminal, that is, inside the riveting terminal, the riveting terminal and each of the heating wire 2 and the electronic wire 4 squeeze one another to be in contact with one another, so as to achieve the electric connection between the heating wire 2 and the electronic wire 4. A riveting hole may be provided in the connecting terminal 3, and the electronic wire 4 and the connecting terminal 3 are both riveted to the riveting terminal and are in close contact with each other, so as to achieve the electric connection. Apparently, the connecting terminal 3 may also be connected to the electronic wire 4 by welding, and the connection manner is not limited herein.

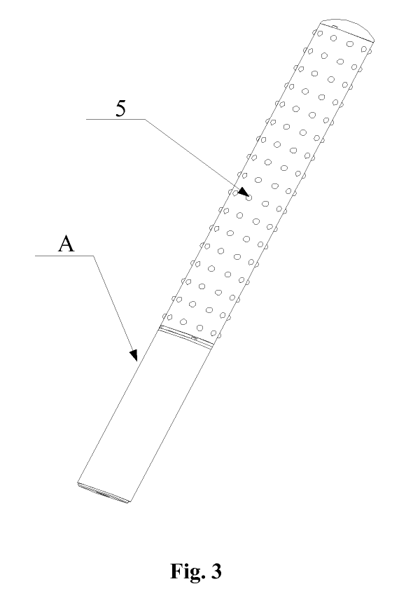

Referring to FIGS. 1 and 3, based on the atomizer B according to the above embodiments, an electronic cigarette A is further provided according to the present application, which includes an atomizer B and a battery rod. The atomizer B is the atomizer according to any one of the above embodiments. Since the atomizer according to the above embodiments has the above technical effects, the electronic cigarette A also has the same technical effects, which are therefore omitted herein for simplicity.

Preferably, for facilitating taking up and putting down the electronic cigarette A, a protruding friction portion 5 may also be arranged on an outer surface of the electronic cigarette A, which may prevent the electronic cigarette A from being detached from the hand of the user and further prevent the electronic cigarette A from falling off. Further, the friction portion 5 may be in a cylindrical shape, or a rubber sleeve may be arranged on the surface of the electronic cigarette A, and an outer surface of the rubber sleeve is provided with a texture to increase the friction.

In this embodiment, the electronic cigarette A is an electronic cigarette with the atomizer and the battery rod being detachably connected. It is to be appreciated that, the electronic cigarette according to other embodiments may be an electronic cigarette with the atomizer and the battery rod formed in a non-detachable integral structure.

The above embodiments are described in a progressive manner. Each of the embodiments is mainly focused on describing its differences from other embodiments, and references may be made among these embodiments with respect to the same or similar portions among these embodiments.

Based on the above description of the disclosed embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. A connecting terminal of a heating wire, configured to connect a heating wire to an electronic wire of an electronic cigarette, and the electronic wire being configured to supply power to the heating wire wherein the connecting terminal is made of white copper.

2. 10 The connecting terminal of the heating wire according to claim 1, wherein the white copper contains 17.0% to 35.0% nickel, by weight.

3. The connecting terminal of the heating wire according to claim 1, wherein the white copper is a copper-nickel binary alloy.

4. The connecting terminal of the heating wire according to claim 1, wherein the white copper is a multicomponent alloy formed by adding one or more components of iron, zinc, aluminum, and manganese into copper and nickel.

5. The connecting terminal of the heating wire according to claim 1, wherein the connecting terminal is a riveting terminal riveted to the heating wire and the electronic wire.

6. An atomizer, configured to form an electronic cigarette in combination with a battery rod, comprising a liquid guide cord, a heating wire in contact with the liquid guide cord, a connecting terminal electrically connected to the heating wire, and an electronic wire electrically connected to the connecting terminal and configured to supply power to the heating wire, wherein the connecting terminal of the heating wire is made of white copper.

7. The atomizer according to claim 6, wherein the liquid guide cord is a fiber cord.

8. The atomizer according to claim 6, wherein the heating wire is wound on the liquid guide cord.

9. An electronic cigarette, comprising an atomizer and a battery rod, wherein the atomizer comprises a liquid guide cord, a heating wire in contact with the liquid guide cord, a connecting terminal electrically connected to the heating wire, and an electronic wire electrically connected to the connecting terminal and configured to supply power to the heating wire, and the connecting terminal of the heating wire is made of white copper

10. The electronic cigarette according to claim 9, wherein an outer surface of the electronic cigarette is provided with a protruding friction portion.

11. The atomizer according to claim 6, wherein the white copper contains 17.0% to 35.0% nickel, by weight.

12. The atomizer according to claim 6, wherein the white copper is a copper-nickel binary alloy.

13. The atomizer according to claim 6, wherein the white copper is a multicomponent alloy formed by adding one or more components of iron, zinc, aluminum, and manganese into copper and nickel.

14. The atomizer according to claim 6, wherein the connecting terminal is a riveting terminal riveted to the heating wire and the electronic wire.
